(19) United States
(12) Patent Application Publication
(10) Pub. No.: US 2014/0346788 A1
(43) Pub. Date: Nov. 27, 2014

(54) Entrance Door Security System

(71) Applicant: Robert E. Cutrer, Lake Jackson, TX (US)

(72) Inventor: Robert E. Cutrer, Lake Jackson, TX (US)

(21) Appl. No.: 14/454,584

(22) Filed: Aug. 7, 2014

Related U.S. Application Data
(63) Continuation-in-part of application No. 12/760,027, filed on Apr. 14, 2010.

(51) Int. Cl. E05B 15/02

(52) U.S. Cl. CPC E05B 15/02
USPC 292/357

(57) ABSTRACT

An entrance door security system is provided, comprising a door reinforcement assembly; having a front plate, with an indent and a deadbolt hole, with an extended door reinforcement cylinder extending from deadbolt hole, and also having opposing flanges extending over the interior face and exterior faces of the door, adapted to receive a deadbolt assembly within a deadbolt bore; and door reinforcement bolts inserted through the door and establishing a secure fit between the opposing flanges. The bolts are secured by a threaded nut on the exterior face of the door with a smooth head to prevent disassembly from the exterior side. A deadbolt striker plate assembly, and a security hinge assembly are also provided, such that all three weak areas of the door are more resistant to attempts to breach the door, thus providing extreme entrance door security.

### CROSS-REFERENCE TO RELATED APPLICATIONS

This application is a continuation-in-part of U.S. Ser. No. 12/760,027, filed Apr. 14, 2010.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to entrance door security hardware, and more particularly to an improved door security hardware system, for preventing or delaying unauthorized intrusion.

2. Description of Related Art

Conventional door assemblies are comprised of a hinged door residing within a casing nailed to an interior wall structure. The door latch engages a striker plate which is typically attached to the casing by a pair of screws. If a dead bolt lock is also employed, the bolt engages its own striker plate attached to the casing in a similar manner as the door latch striker plate. In most conventional door assemblies, the casing is about 3/4 inch thick, which means that the thin metal striker plate or the casing itself is not sufficient to withstand an attempted forced entry.

Numerous designs have been proposed over the years which are directed to improving the strength of conventional door assemblies. One disadvantage of many designs is that they are intended for installation with original construction, i.e. when the home is being built, because the alternative hardware is easier to install when the interior wall structure is exposed.

Another disadvantage is that many security hardware systems are bulky and unsuitable for home use where traditional trim molding and other decorative features are desired by the homeowner. A third disadvantage is that such security hardware may be difficult to install for the typical “do it yourself” homeowner.

Over the years, inventors have focused on one or two weak points in the door assembly, and such solutions are generally more effective than the conventional hardware. However, none of those solutions appears to accomplish the primary objective, which is to prevent the entrance door from being breached. For example, in U.S. Pat. No. 6,679,019 to Rochman, U.S. Pat. No. 5,269,100 to Fontenot, and in my prior patent, U.S. Pat. No. 7,520,544, none of those devices provide sufficient reinforcement in all three critical areas of the door to be effective against the most common breaching of the door. Mechanical failure in response to breaching forces most often occurs in the casing where the striker plate in which the deadbolt resides when locked, at the hinges of the door, at the door edge where the door latch and deadbolt reside, or a combination of those events.

With respect to Rochman, the reinforcement plate present in that assembly could not prevent the door from being breached for several reasons. First, the reinforcement plate only supports the inner portion of the door deadbolt bore, which only supports the deadbolt bore. It cannot prevent the deadbolt from pivoting. Second, the reinforcement plate includes no support for the outer edges of the door, enabling the door to split or separate due to lack of support. Finally, the Rochman patent includes no support for the door casing on the latch side, or the hinge side, although both of these areas are subject to failure during an attempted breach.

With respect to Fontenot, that system does include a door reinforcement plate that wraps around the door itself. However, that assembly is insufficient to prevent the door from being breached for several reasons. First, the door reinforcement plate in Fontenot does not provide a close fit against the latch or deadbolt itself, and a breaching force would still allow the deadbolt to pivot within the softer wood in which it is installed. Second, the door reinforcement plate of Fontenot is inadequately anchored, being attached to the door only by short anchoring screws. These short screws are easily displaced during a strong breaching impact, and would allow the door edges to split, resulting in movement of the installed deadbolt away from its fully engaged position within the striker plate. Finally, although the Fontenot assembly includes an improved striker plate, that device is not sufficiently strong to resist a breaching force, because it is merely attached through the casing and the wall studs via conventional screws, and with no other metal plate as reinforcement.

Moreover, neither Fontenot or Rochman address the hinge side of the door assembly, leaving another conspicuous weak point in their respective systems. In contrast, my prior patents, U.S. Pat. No. 7,520,544 and U.S. Pat. No. 5,570,917, directly address the hinges as a weak area, and have provided a superior solution against breaching attempts on the hinge side of the door.

Despite the advantages and success of prior art designs, none of the above systems were designed to resolve all three weak points of the door system. Therefore, there is a need for a door security system which remains inexpensive, easy to install, and effective in withstanding the sudden and intense impact of a forced entry attempt.

### SUMMARY OF THE INVENTION

In a door having an end face, an exterior face, and an interior face, a door reinforcement assembly is adapted to receive a deadbolt assembly, wherein the door reinforcement assembly includes a front plate with an indent having a deadbolt hole and an extended door reinforcement cylinder designed to receive the deadbolt assembly, wherein the door reinforcement cylinder is positioned within the deadbolt bore of the door. The door reinforcement assembly also includes a first flange extending from the front plate over the interior face of the door , and a second flange extending from the front plate over the exterior face of the door, wherein each of the first and second flanges includes a plurality of mounting holes; and two door reinforcement bolts, wherein each of the door reinforcement bolts are inserted through the mounting holes aligned between the first and second flanges and through a bolt hole formed in the door, and wherein each of the door reinforcement bolts are secured by a threaded nut.

More preferably, the indent of the door reinforcement assembly is shaped and dimensioned to permit the face of the deadbolt assembly when installed in the door, to be flush with the front plate of the door reinforcement assembly, resulting in a matable engagement between the face of the deadbolt and the indent.

Also preferably, the deadbolt hole and door reinforcement cylinder of the door reinforcement assembly is shaped and dimensioned to permit slideable passage of a deadbolt assembly.

Also preferably, the front plate of the door reinforcement assembly includes mounting holes aligned with mounting holes of the deadbolt assembly mounting plate.

As an additional security measure, each of the door reinforcement bolts are inserted from the exterior side of the door, and wherein each of the bolts includes a smooth head to prevent disassembly from the exterior side of the door.

An entrance door security system is also provided, comprising a door reinforcement assembly as described above; and a deadbolt striker plate assembly comprising a deadbolt striker plate having a striker face plate and an enclosed housing adapted to receive a deadbolt from the deadbolt assembly, wherein the striker face plate is attached to a door casing and wall stud by a first plurality of fasteners; and a reinforcing member comprising a first flange parallel to the striker face plate having an opening adapted to matably and interlockingly surround and engage the housing of the deadbolt striker plate, and a second flange perpendicular to the first flange having a first hole pattern, wherein the second flange of the reinforcing member is attached to a wall stud by a second plurality of fasteners.

More preferably, the deadbolt striker plate assembly further includes a shim plate having a second hole pattern adapted to matably engage the first hole pattern of the second flange of the reinforcing member, and wherein the first hole pattern comprises at least two holes adapted to receive mounting screws. The shim plate preferably will vary in thickness, depending on the thickness of the interior wall thickness (i.e. ½″ sheetrock), assuring a perfect alignment of the deadbolt striker plate assembly when installed.

Also in the embodiment, the entrance door security system further includes a security hinge assembly connected between the door, the door casing and an interior wall structure, wherein the security hinge assembly comprises first and second hinging plates operatively connected by a pin, wherein the first hinging plate is attached to the door and includes a backstop plate; and wherein the second hinging plate includes an anchoring plate attached to the interior wall structure.

### BRIEF DESCRIPTION OF THE DRAWINGS

For a further understanding of the nature, objects, and advantages of the present invention, reference should be made to the following detailed description, read in conjunction with the following drawings, wherein like reference numerals denote like elements.

FIG. 1 is a perspective view of the door reinforcement assembly.

FIG. 2 is a perspective view of the deadbolt striker plate assembly.

FIG. 3 is a perspective view of the security hinge assembly.

FIG. 4 is a view of a mounting screw.

FIG. 5 is an exploded view of the door reinforcement assembly.

FIG. 6 is a top sectional view of a prior art conventionally installed deadbolt mechanism, depicting the doors weak points which allows the deadbolt to pivot under impact forces.

FIG. 7 is a top sectional view of the door reinforcement assembly in an installed configuration.

FIG. 8 is a top sectional view of the door reinforcement assembly, the deadbolt striker plate assembly, and the security hinge assembly in an installed configuration.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

Importantly, this invention builds upon the door security devices which are described in my two prior patents, U.S. Pat. No. 7,520,544 and U.S. Pat. No. 5,570,917. Therefore, those disclosures are hereby and expressly incorporated by reference herein.

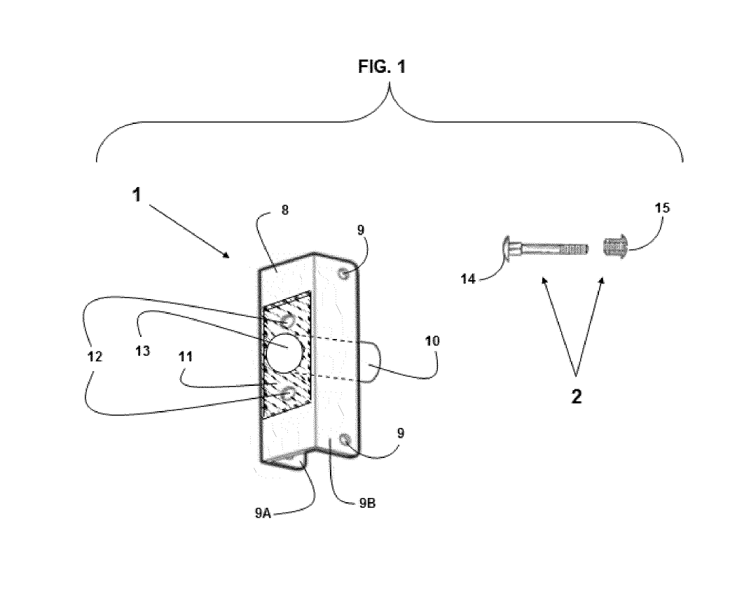

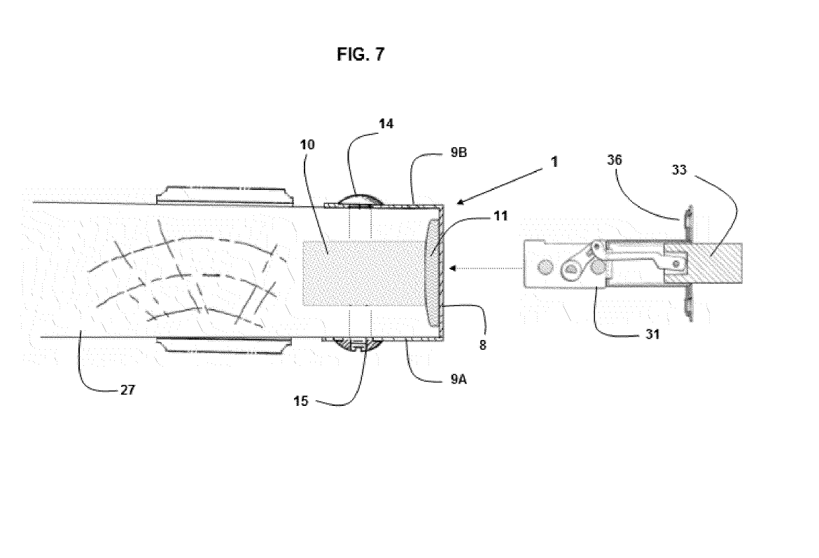

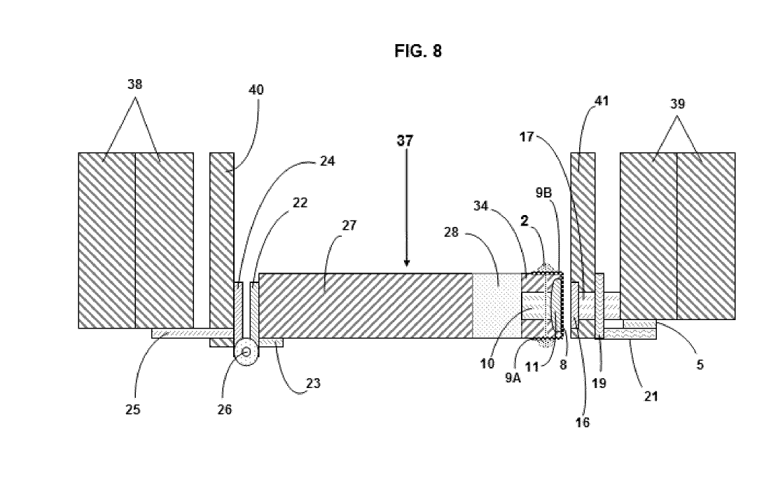

Turning now to FIG. 1, FIG. 5, FIG. 7, as well as FIG. 8 for the description of each component of the door reinforcement assembly 1, an assembly view is shown for the preferred embodiment of the present invention, which comprises several components that operate with a door 27 in order to provide enhanced security against an attempted breach of the door. The door reinforcement assembly 1, wherein includes a front plate 8 with an indent 11 having a hole 13 and an extended door reinforcement cylinder 10 designed to receive a deadbolt assembly 31, wherein the door reinforcement cylinder 10 is positioned within the deadbolt bore 29 of the door 27. The front plate 8 includes a first flange 9A extending from the front plate 8 over the interior face of the door 27, and a second flange 9B extending from the front plate 8 over the exterior face of the door 27. Each of the first and second flanges 9A, and 9B includes a plurality of mounting holes 9. The door reinforcement assembly 1 is secured to the door 27 with two door reinforcement fasteners 2, wherein each of the door reinforcement fasteners 2 is inserted through the mounting holes 9 aligned between the first and second flanges 9A, and 9B and through a bolt hole 30 formed in the door 27. In practice, the bolt holes 30 will be formed by using the mounting holes 9 as a guide to ensure a tight fit onto the door 27. Each of the door reinforcement fasteners 2 will typically include a bolt 14 secured by a threaded nut 15 having means to accept the desired screwdriver bit, e.g. phillips, flat head, etc. Preferably, each of the door reinforcement bolts 14 is inserted from the exterior side of the door 27, and wherein each of the bolts 14 includes a smooth head to prevent disassembly from the exterior side of the door 27.

The deadbolt hole 13 and the door reinforcement cylinder 10 of the door reinforcement assembly 1, are shaped and dimensioned such that the door reinforcement cylinder 10 fits snugly within the deadbolt hole 13, and to permit slideable insertion of a deadbolt assembly 31. Thus, the internal diameter of the deadbolt hole 10 must be large enough for insertion of the deadbolt assembly 31, but small enough to establish a snug fit with little play.

Also, the front plate 8 of the door reinforcement assembly 1 includes mounting holes 12 alignable with mounting holes on the mounting plate 36 of the deadbolt assembly 31 in FIG. 5. When assembled, the mounting plate 36 of the deadbolt assembly 31 resides within the indent 11, establishing a matable engagement between the mounting plate 36 and the indent 11, and resulting in a flush surface across the mounting plate 36 and the front plate 8.

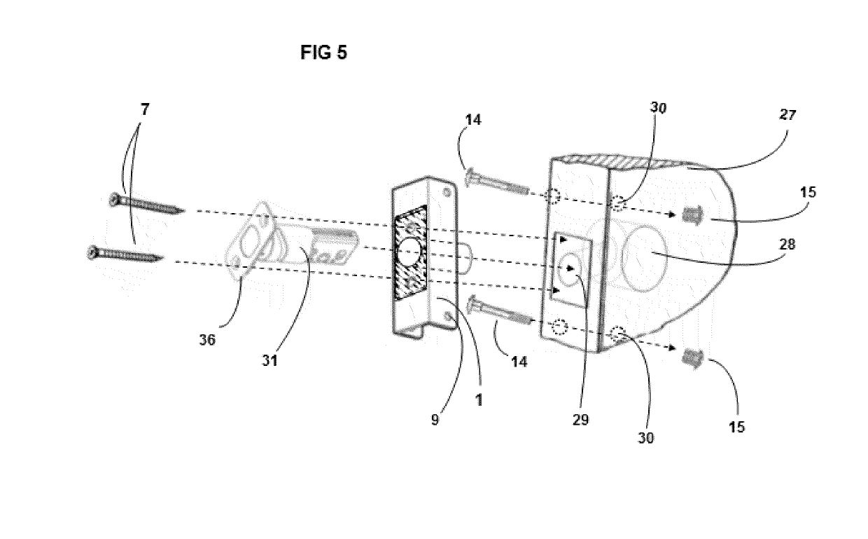

Thus, when these components of the invention are fully assembled, the fasteners 7 of FIG. 4 are used to secure two items to the end face of the door 27 simultaneously, namely the front plate 8 of the door reinforcement assembly 1, and the deadbolt assembly 31. As can be appreciated, when the door reinforcement fasteners 2 are installed through the flanges 9A, and 9B, the deadbolt assembly 31 is now quite securely mounted within the door 27, such that when force vector 37 (shown in FIG. 8) is applied to the door 27, the resulting assembly will substantially reduce the movement or pivoting of the deadbolt 33, or failure of the door 27 itself. Moreover, the door reinforcement assembly 1 with its strongly secured flanges 9A and 9B add structure to the door 27 at its most vulnerable point during an attempted breach, thus minimizing the possibility of breakage or splintering the door 27. This assembly is suitable for any solid wooden door 27, but even stronger when steel covered doors are employed.

During assembly of the components described herein, it is necessary to deepen the door end face recess within which the face plate of the deadbolt assembly 31 resides, because it is desirable that the indent 11 of the door reinforcement assembly 1 mounts deeper into the end face of the door 27. When that is accomplished, the material thickness of the door reinforcement assembly 1 should not interfere with the fit of the door 27 within its casing 41.

As can be appreciated, the foregoing assembly does not change the manner in which the deadbolt assembly 31 operates within the door 27, because the operating mechanism remains aligned within the deadbolt basket 28 of the door 27 Likewise, as further illustrated in FIG. 7, the flanges 9A, and 9B of the door reinforcement assembly 1 do not obstruct the deadbolt basket 28.

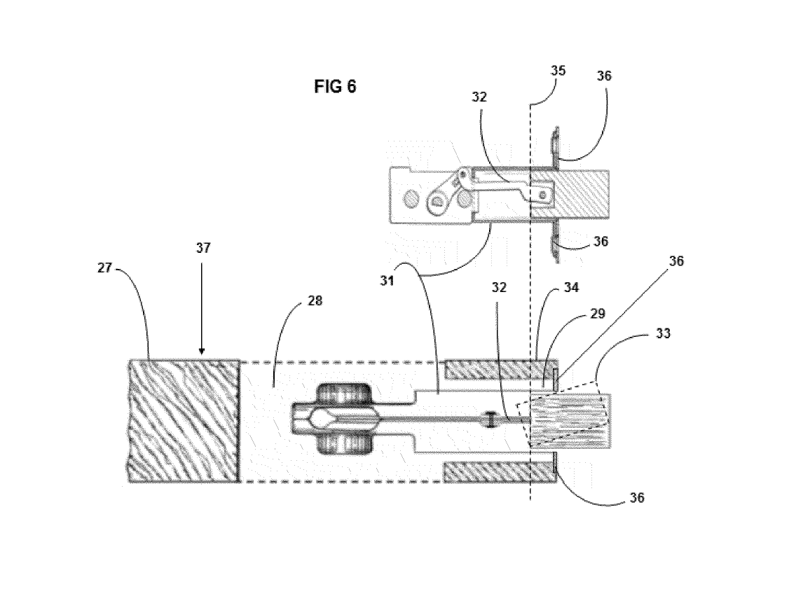

The advantages of the present invention are best understood in comparison to existing or prior art assemblies, such as the sectional views shown in FIG. 6, which depicts a standard deadbolt assembly 31 mounted in the conventional manner. Weak points in the prior art assembly allow the deadbolt 33 to pivot under impact pressure due to a breach attempt applied to the door 27 along force vector 37. Because of the design of conventional doors 27 and the deadbolt linkage 32, the deadbolt 33 is able to pivot due to only about 1/4″ of the deadbolt 33 is actually in the door 27. This distance can be seen between the phantom line 35 and the mounting plate 36. Furthermore, the door edge 34 is a weak point, because the typical 1″ deadbolt bore 29 only leaves about a 3/8″ strip of wood on either side of the deadbolt bore 29, which can allow that area to split and separate. Thus, upon a breach attempt along force vector 37, the deadbolt 33 is caused to pivot against the face plate 36=due to the weak point of the door edge 34. Even if the deadbolt 33 does not pivot, the weak door edge 34 will fail in response to the force 37.

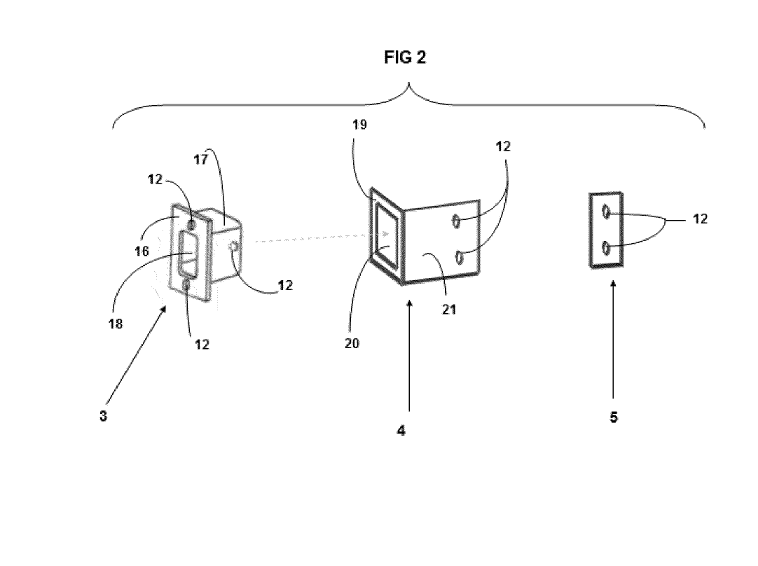

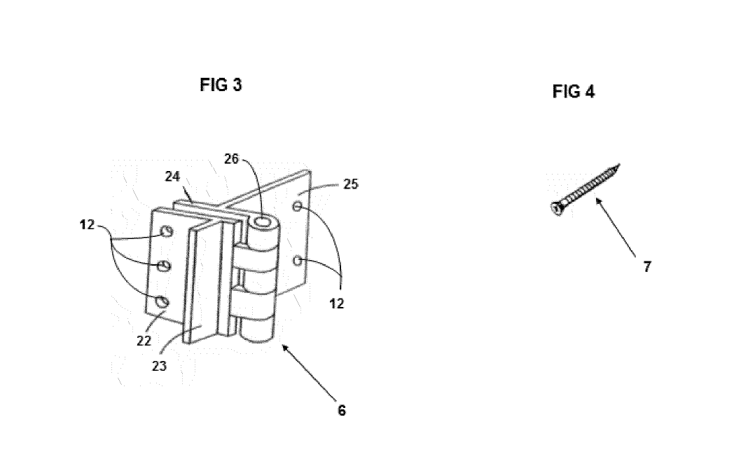

As stated above, this invention has its greatest utility when used in combination with my prior inventions disclosed in U.S. Pat. No. 7,520,544 and U.S. Pat. No. 5,570,917, the disclosures of which are incorporated herein by reference. Specifically, and with regard to FIG. 2, and FIG. 8, a deadbolt striker plate assembly 3,4, and 5 can be employed, which comprises a deadbolt striker face plate 16 and an enclosed housing 17 adapted to receive a deadbolt 33 of FIGS. 6 and 7 into cavity 18 from the deadbolt assembly 31. The striker face plate 16 is attached to a door casing 41 by standard fasteners, such as screws 7, through mounting holes 12. An additional screw is used through hole 12 in the rear of the housing 17 to secure the housing 17 to the wall stud 39.

A reinforcing member 4 for extreme entrance door security is provided, which comprises a first flange 19 parallel to the striker face plate 16, and having an opening 20 adapted to matably and interlockingly surround and engage the deadbolt housing 17, and a second flange 21 perpendicular to the first flange 19 having a first hole pattern 12. As illustrated in FIG. 8, the second flange of the reinforcing member 4 is attached to a wall stud 39, typically by standard fasteners 7 as shown in FIG. 4 Depending upon the specific situation, a suitably sized shim 5 may also be employed to align the components properly.

Furthermore, as illustrated in FIG. 8, on the hinge side of the door 27, the entrance door security system further includes a security hinge assembly 6 for extreme entrance door security, connected to the door 27, the door casing 40, and an interior wall structure 38 (such as wall studs 39). Preferably, at least one such security hinge assemblies 6 would be employed for maximum strength and effectiveness. The security hinge assembly 6 comprises a first and a second hinging plates 22, and 24 operatively connected by a pin 26. The first hinging plate 22 is attached to the door 27 and includes a backstop plate 23. The backstop plate 23 can prevent dislodgement of the fasteners 7 connecting the plate 22 to the door 27 during a breach attempt along force vector 37. Similarly, the second hinging plate 24 includes an anchoring plate 25 attached to the interior wall structure 38. The security hinges 6 are much stronger than conventional door hinges, because they provide direct reinforcement along planes which are perpendicular to the applied force vector 37. When it is used in combination with the other components described and claimed herein, the overall system provides extreme entrance door security against breaches which is far superior to conventional door hardware.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. In a door having an end face, an exterior face, and an interior face, a door reinforcement assembly, comprising:
(a) a door reinforcement assembly having a front plate with an indent and a deadbolt hole, with an extended door reinforcement cylinder extending from the deadbolt hole and adapted to receive a deadbolt assembly, wherein the door reinforcement cylinder is positioned within a deadbolt bore of the door, and wherein the front plate is secured to the door by a plurality of fasteners; and also including a first flange extending from the front plate over the interior face of the door, and a second flange extending from the front plate over the exterior face of the door, wherein each of the first and second flanges includes a plurality of mounting holes; and
(b) one or more door reinforcement bolts, wherein each of the door reinforcement bolts is inserted through the mounting holes aligned between the first and second flanges and through a bolt hole formed in the door, and wherein each of the door reinforcement bolts is secured by a threaded nut.

2. The assembly of claim 1, wherein the front plate of the door reinforcement assembly includes front plate mounting holes aligned with mounting holes on the deadbolt assembly.

3. The assembly of claim 1, wherein the deadbolt hole and door reinforcement cylinder of the door reinforcement assembly, are shaped and dimensioned to permit slideable insertion of a deadbolt assembly.

4. The assembly of claim 1, wherein the front plate of the door reinforcement assembly includes an indent to receive the deadbolt assembly mounting plate, and also includes mounting holes aligned with the mounting holes on the deadbolt assembly, establishing a matable engagement between the deadbolt assembly mounting plate and the indent, and resulting in a flush surface across the deadbolt assembly mounting plate and the front plate of the door reinforcement assembly.

5. The assembly of claim 1, wherein each of the door reinforcement bolts is inserted from the exterior side of the door, and wherein each of the bolts includes a smooth head to prevent disassembly from the exterior side of the door.

6. In a door having an end face, an exterior face, and an interior face, an entrance door security system, comprising:
(a) a door reinforcement assembly having a front plate with an indent and a deadbolt hole, with an extended door reinforcement cylinder extending from the deadbolt hole and adapted to receive a deadbolt assembly, wherein the door reinforcement cylinder is positioned within a deadbolt bore of the door, and wherein the front plate is secured to the door by a plurality of fasteners; and also including a first flange extending from the front plate over the interior face of the door, and a second flange extending from the front plate over the exterior face of the door, wherein each of the first and second flanges includes a plurality of mounting holes; and
one or more door reinforcement bolts, wherein each of the door reinforcement bolts is inserted through the mounting holes aligned between the first and second flanges and through a bolt hole formed in the door, and wherein each of the door reinforcement bolts is secured by a threaded nut; and
(b) a deadbolt striker plate assembly, comprising:
a deadbolt striker plate having a striker face plate and an enclosed housing adapted to receive a deadbolt from the deadbolt assembly, wherein the striker face plate is attached to a door casing by a second plurality of fasteners; and
a reinforcing member comprising a first flange parallel to the striker face plate having an opening adapted to matably and interlockingly surround and engage the housing of the deadbolt striker plate, and a second flange perpendicular to the first flange having a first hole pattern, wherein the second flange of the reinforcing member is attached to a wall stud by a third plurality of fasteners.

7. The system of claim 6, further including at least one security hinge assembly connected between the door, the door casing and an interior wall structure, wherein the security hinge assembly comprises first and second hinging plates operatively connected by a pin, wherein the first hinging plate is attached to the door and includes a backstop plate; and wherein the second hinging plate includes an anchoring plate attached to the interior wall structure.

8. The system of claim 6, wherein the deadbolt striker plate assembly further includes a shim plate having a second hole pattern adapted to matably engage the first hole pattern of the second flange of the reinforcing member, and wherein the first hole pattern comprises at least two holes adapted to receive mounting screws.

9. The system of claim 6, wherein front plate of the door reinforcement assembly includes front plate mounting holes aligned with mounting holes on the deadbolt assembly.

10. The system of claim 6, wherein the deadbolt hole and door reinforcement cylinder of the door reinforcement assembly, are shaped and dimensioned to permit slideable insertion of a deadbolt assembly.

11. The system of claim 6, wherein each of the door reinforcement bolts is inserted from the exterior side of the door, and wherein each of the bolts includes a smooth head to prevent disassembly from the exterior side of the door.
